(19) United States
(12) Patent Application Publication
(10) Pub. No.: US 2005/0198047 A1
(43) Pub. Date: Sep. 8, 2005

(54) Method of managing advanced engineering activities

(76) Inventors: Patrick Garcia, Lauterbourg (FR); Edward C. Hill, Jackson, MI (US); Charles J. Hass, Brighton, MI (US)

Correspondence Address: HARNESS, DICKEY & PIERCE, P.L.C., P.O. BOX 828, BLOOMFIELD HILLS, MI, 48303, US

(21) Appl. No.: 10/793,503

(22) Filed: Mar. 4, 2004

(51) Int. Cl. G06F 17/30

(52) U.S. Cl. 707/100

(57) ABSTRACT

A method of managing advanced engineering activities is provided. First, customer requirements are collected from a plurality of customers. Next, a plurality of projects tailored to satisfy the customer requirements are proposed. Then, internal capabilities are compared with the customer requirements for each proposed project. A gap is defined for each proposed project as the difference between the customer requirements and the internal capabilities. Finally, each proposed project is scored to determine which proposed projects to activate.

### FIELD OF THE INVENTION

The present invention relates to a method of managing advanced engineering activities within an organization and, more particularly, a method of analyzing customer demands to selectively pursue advanced engineering projects tailored to the customer demands.

### BACKGROUND OF THE INVENTION

Organizations, such as original equipment manufacturers, often request suppliers to provide new products and/or services. Most suppliers have advanced engineering programs to conduct projects tailored to producing results to satisfy these requests. In deciding whether to pursue certain projects, the supplier typically makes an assessment of its internal capabilities and conducts a cost/benefit analysis. In today's environment, however, this analysis can often be made in haste with little or no objectivity. This can lead to future problems. Problems tend to include ballooning costs and project scope variation. These types of problems can frustrate the project personnel including the engineers and managers, and more importantly, the customer manufacturers.

Therefore, it is desirable to provide a method for managing advanced engineering activities within an organization such as an automotive component supplier that addresses the aforementioned, as well as other deficiencies.

### SUMMARY OF THE INVENTION

A method of managing advanced engineering activities is provided. First, customer requirements are collected from a plurality of customers. Next, a plurality of projects tailored to satisfy the customer requirements are proposed. Then, internal capabilities are compared with the customer requirements for each proposed project. A gap is defined for each proposed project as the difference between the customer requirements and the internal capabilities. Finally, each proposed project is scored to determine which proposed projects to activate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart of a method of managing advanced engineering activities in accordance with the present invention;

FIG. 2 is a flowchart of an exemplary method of managing advanced engineering activities in accordance with the present invention;

FIG. 3 is a flowchart of an exemplary method of scoring Proposed Projects in accordance with the method of FIG. 2;

FIG. 4 is a table presenting customer requirements for a plurality of customers in accordance with the method of FIG. 2;

FIG. 5 is a bar graph presenting customer demands for a plurality of customers in accordance with the method of FIG. 2;

FIG. 6 is a bar graph presenting capability gaps for a plurality of Proposed Projects in accordance with the method of FIG. 2;

FIGS. 7A-7D are tables presenting scores for the plurality of projects in accordance with the method of FIG. 2;

FIG. 8 is a graph presenting results of a screening process in accordance with the method of FIG. 2;

FIG. 9 is a table presenting a Master Project List in accordance with the method of FIG. 2;

FIG. 10 is a table presenting the timing status of a plurality of Active Projects in accordance with the method of FIG. 2;

FIG. 11 is a graph presenting a percentage of Active Projects proceeding on time in accordance with the method of FIG. 2 over a period of time;

FIG. 12 is a bar graph representing costs associated with the Active Projects in accordance with the present invention; and

FIG. 13 is a diagrammatical view of a computer-implemented system in accordance with the present invention.

### DETAILED DESCRIPTION

The following description of the preferred embodiments is merely exemplary in nature and is in no way intended to limit the scope of the invention, its application, or its uses.

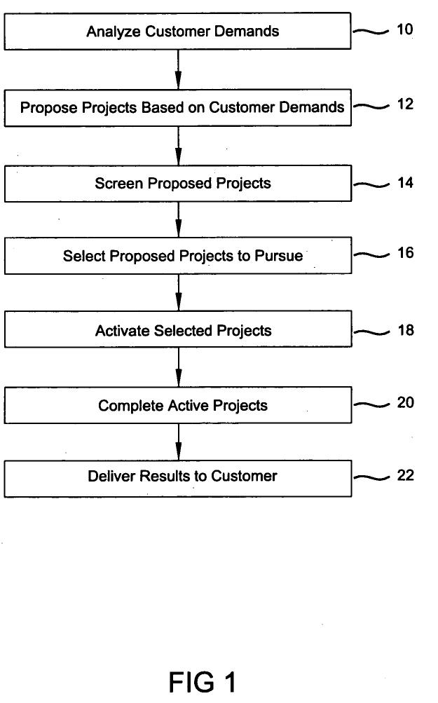

With reference to FIGS. 1-12 an exemplary method of managing an advanced engineering program within an Organization is described. Advanced engineering programs often include advanced engineering activities, such as research and development projects, tailored to producing new products, tools and/or services. It should be appreciated, however, that while the exemplary embodiment of the present invention is described as managing engineering activities, other activities such as business, accounting, and marketing activities can also be managed by the method of the present invention. Furthermore, Organizations, as used herein, is intended to include engineering organizations, manufacturing organizations, marketing organizations, service organizations, or any combination thereof.

FIG. 1 depicts a method of managing advanced engineering projects within an Organization. First, customer requirements are analyzed 10. Customer requirements are typically communicated to the Organization either at the customer's initiative or at the Organization's request. In an exemplary embodiment, customer requirements include parameters specifying new or improved products or services, as well as the urgency at which the customers require these products or services. It should be noted that while only a number of customer requirements have been listed, alternative or supplemental requirements are intended to be within the scope of the present invention. An exemplary method of analyzing customer requirements is described in more detail below.

Once the customer requirements have been analyzed, a plurality of advanced engineering projects are proposed 12. Each Proposed Project is tailored to satisfy a single or a plurality of customer requirements. In an exemplary embodiment, each Proposed Project has a distinct project scope. Next, the Proposed Projects are screened 14 for feasibility. Screening includes identifying the benefits and/or risks associated with pursuing each of the Proposed Projects and weighing them. Benefits associated with advanced engineering projects include gaining a strategic and/or market advantage over competitors. Risks associated with advanced engineering projects include financial risks and technical risks. Financial risks include the amount of manpower required to complete a project and the costs associated with conducting tests or research. Technical risks include risks associated with pursuing novel technologies. It should be appreciated that alternative and/or supplemental benefits and risks are intended to be within the scope of the present invention. Based on this cost/benefit analysis, the Organization selects 16 at least one proposed project to pursue. The selected project or projects are then activated 18.

Activation includes assigning project personnel, acquiring assets, setting goals, and distributing assignments. At some point subsequent to activation, the project or projects are completed 20 and their results are delivered 22 to the customers. The results of each project depends on the scope, but typically includes an actual product or a new service offered by the Organization. In the case that the result is an actual product, the product is accompanied with some sort of documentation when delivered to the customers. The documentation can include a project summary, a detailed product specification, a durability report, and any manufacturing recommendations. In the case that the result includes a new service, the documentation may include a project summary, a report detailing the scope of the new service, and the costs for rendering the service. It should be appreciated that while only a few items have been listed as being documented to the customer, alternative and/or supplemental items are intended to be within the scope of the present invention. It should further be appreciated that the subject matter of this documentation must be acquired from multiple individuals within the Organization. For example, design engineers will provide technical specifications, test engineers will provide the durability reports, and manufacturing engineers will provide the manufacturing recommendations. Therefore, in an exemplary embodiment, the results are compiled on an Organizational intranet. This enables the project personnel to access and supplement the documentation within their own field of expertise. Finally, this documentation may be downloaded from the intranet and delivered to the customers. This step is completed by the project manager or a member of the sales personnel who are in communication with the customers.

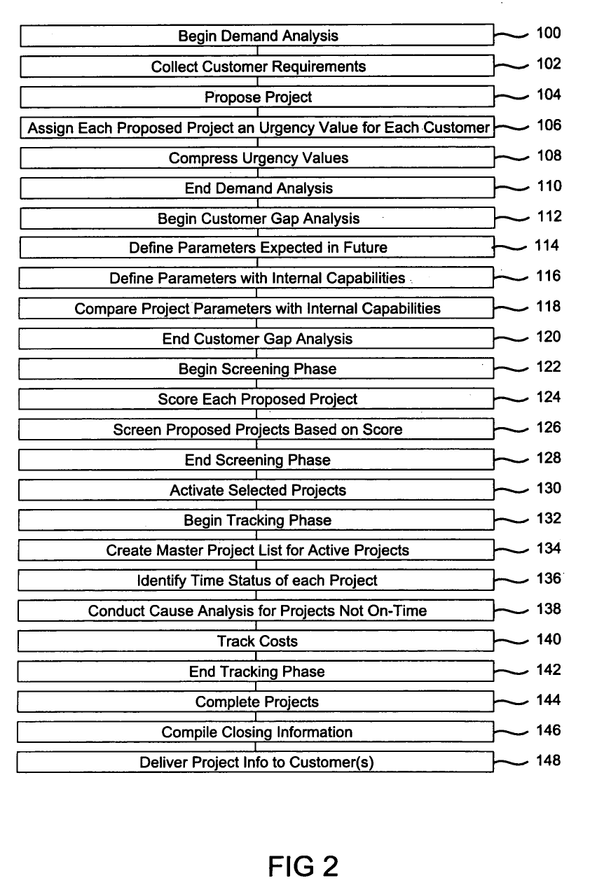

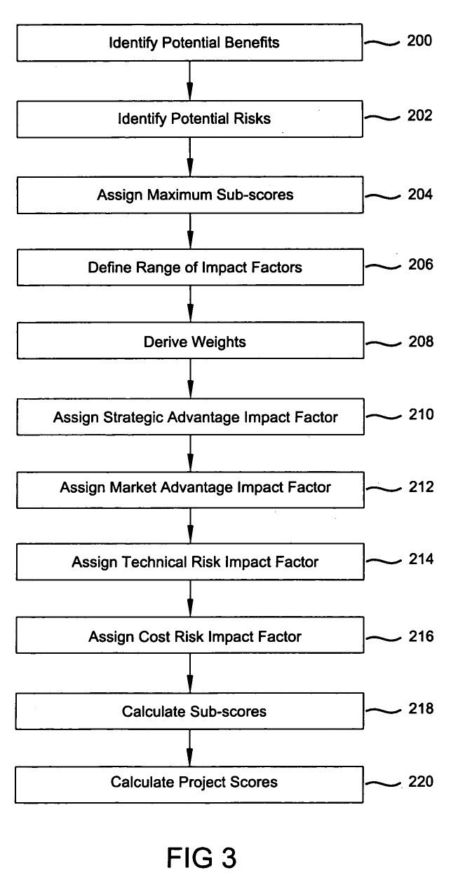

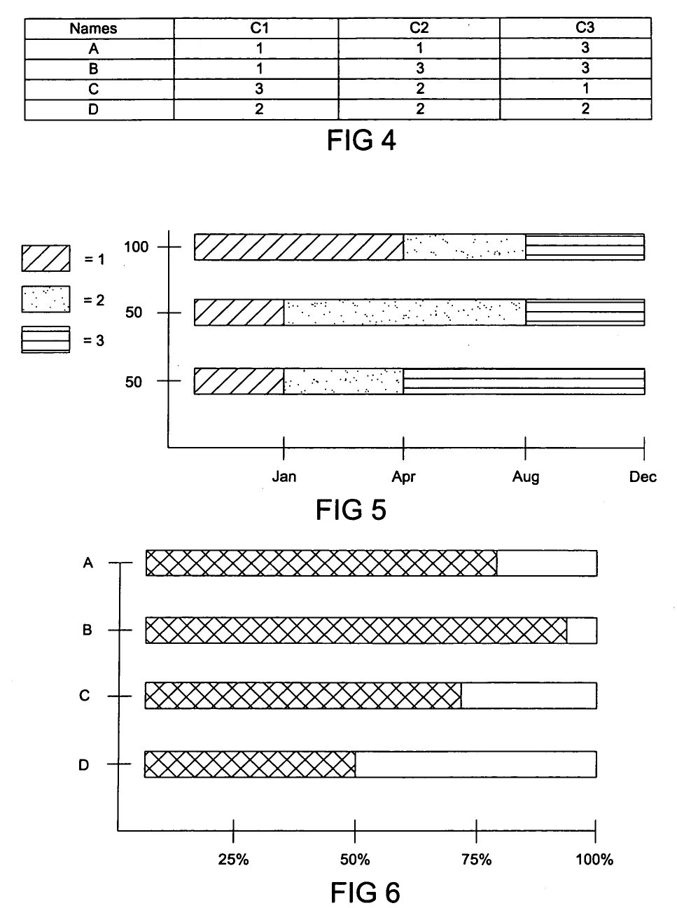

FIGS. 2 and 3 depict an exemplary method of managing advanced engineering activities in more detail than that described above. The first step is to begin 100 a customer demand analysis by collecting customer requirements 102. Based on these requirements, a plurality of projects are proposed 104. The scope of the Proposed Projects are carefully defined to fulfill as many customer requirements as possible. With reference to FIGS. 4-12, the method of FIGS. 2 and 3 will be described in more detail.

FIG. 4 depicts a table presenting customer requirements obtained from three customers, C1, C2, and C3. Each Proposed Project, identified as A, B, C, and D, is assigned a value at step 106 of FIG. 2 that is based on each customer's urgency for obtaining results from the project. In the embodiment illustrated, the urgency values range from “1” to “3.” An urgency value of “1” indicates that the customer currently requires a result from that particular project. More specifically stated, the customer currently requires the product or service that will result from that particular project. Consequently, this means that the Organization is currently incapable of providing that result and, therefore, the customer is likely buying it elsewhere. An urgency value of “2” indicates that the customer does not currently require a result from that project; however, the customer foresees that it will require a result from that project within a predetermined time period. In the embodiment illustrated, that predetermined time period is 2-3 years. It should be appreciated that the predetermined time period could be set to any number of years, months, or days. An urgency value of “3” indicates that the customer currently has no demand for a result from that project and further, has no intentions to require a result from that project in the foreseeable future.

Therefore, FIG. 4 illustrates that Cl currently requires results from projects A and B; has no intention of requiring a result from Project C; and foresees that it will require a result from Project D in 2-3 years. C2 currently requires a result from Project A; has no intention of requiring a result from Project B; and foresees that it will require results from Projects C and D within 2-3 years. C3 has no intention of requiring results from projects A and B; currently requires a result from Project C; and foresees that it will require a result from Project D in 2-3 years. After the urgency values are assigned to each of the Proposed Projects, the urgency values are compressed at step 108 of FIG. 2 to provide a comparison of the customers' demands.

FIG. 5 depicts this comparison in the form of a bar graph. The bar graph is constructed on a percentage calculation of the urgency values tabulated in FIG. 4. For example, C1 currently requires results from two of the three projects, A and B; has no intention of requiring results from one project, C; and foresees it will require results from one project, D, within 2-3 years. Therefore, FIG. 5 illustrates that C1 currently requires results from 50% of the Proposed Projects; foresees that it will require results from 25% of the proposed projects within 2-3 years; and intends never to require results from 25% of the Proposed Projects. Furthermore, C2 currently requires results from 25% of the Proposed Projects; foresees that it will require results from 50% of the Proposed Projects within 2-3 years; and intends never to require results from 25% of the Proposed Projects. Lastly, C3 currently requires results from 25% of the Proposed Projects; foresees that it will require results from 25% of the Proposed Projects within 2-3 years; and has no intention of requiring results from 50% of the Proposed Projects. FIG. 5 provides for a comparison of the demands of each customer, C1, C2, and C3. The significance of this comparison will be realized later when the projects are screened for feasibility and activation. For example, if C1 has the highest demand for results from the Proposed Projects, but will only provide a modest demand for the results after completion of the project, then fulfilling C1's demands may not be such a high priority for the Organization. This ends the demand analysis, as represented by numeral 110 in FIG. 2.

Next, the gap analysis begins 112. First, parameters are defined 114 for each Proposed Project. The parameters are based on the technical results required by the customers within 2-3 years, as opposed to currently. The parameters are obtained directly from the customers. In the case of a project producing results in the form of a product, the parameters can include product dimensions, tolerances, durability, materials, and costs. In the case of a project producing results in the form of services, the parameters can include software programs, personnel acquisitions, and test facilities. It should be appreciated that while only a number of parameters have been listed for both products and services, alternative or supplemental parameters are intended to be within the scope of the present invention.

Once the parameters for each Proposed Project have been defined, the current internal capabilities of the Organization are assessed 116. The internal capabilities should mirror the parameters defined by the customers. For example, if the customer requires the Organization to provide test facilities for providing certain services within 2-3 years, it is assessed whether the Organization currently maintains facilities capable of providing these services. This includes closely defining the internal capabilities of the Organization's facilities. The internal capabilities are then compared 118 with the parameters required in 2-3 years and a gap is defined as the difference. It is important to note that each Proposed Project may have a plurality of parameters. The sum of all the gaps for all of the parameters for each Proposed Project defines the gap for the entire project.

FIG. 6 depicts a bar graph illustrating gaps for the Proposed Projects. For example, FIG. 6 illustrates that the Organization can currently provide only 80% of the parameters defined for Proposed Project A; 90% of the parameters for Proposed Project B; 70% of the parameters for Proposed Project C; and 50% of the parameters for Proposed Project D. FIG. 6 provides an illustration as to what Proposed Projects will require the most attention if activated. It should be appreciated that this comparison is based solely on technical parameters. This ends the gap analysis, as represented by numeral 120 in FIG. 2.

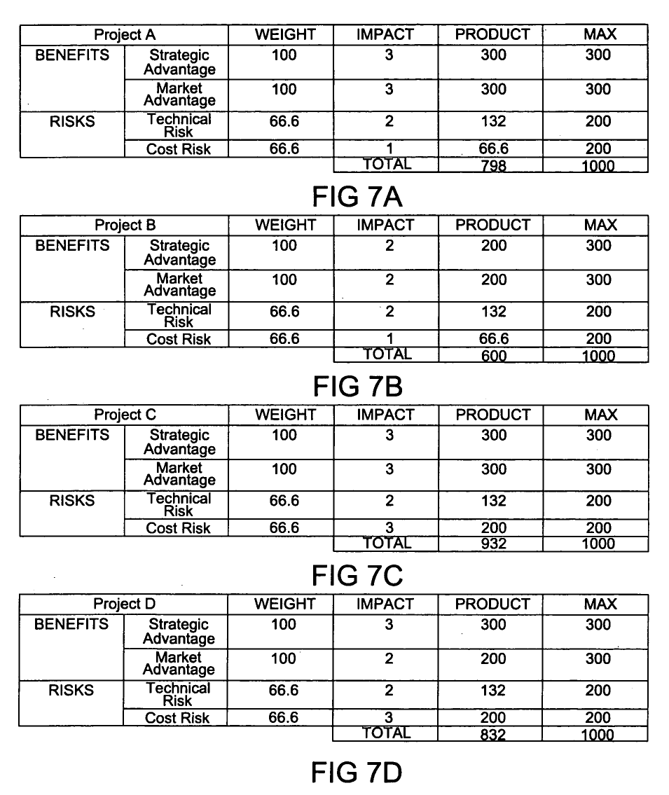

Next, the screening process begins 122. The first step in the screening process is to score 124 each of the proposed projects, thereby weighing the costs and benefits of each project. FIG. 3 depicts this scoring process in more detail with specific reference to FIGS. 7A-7D.

FIGS. 7A-7D illustrate exemplary tables employed in the method of scoring each Proposed Project, wherein the scores determine whether or not the potential benefits outweigh the risks. The scoring system provides for a maximum score of 1000 points for each project. This maximum score is randomly selected to define a basis for comparing the scores. Any maximum score can be used. The first steps to scoring includes identifying potential benefits and risks common to all of the Proposed Projects at steps 200 and 202 of FIG. 3. These are presented in the second columns of FIGS. 7A-7D. In the embodiment illustrated, the potential benefits include Strategic Advantage and Market Advantage. The potential risks include Technical Risks and Cost Risks.

Next, maximum sub-scores are assigned to each of the potential benefits and risks at step 204 of FIG. 3. In the embodiment illustrated, the potential benefits have a maximum sub-score of 300, while the risks have a maximum sub-score of 200. These maximum sub-scores are inserted in the right-most column in FIGS. 7A-7D. The discrepancy in maximum sub-scores between the potential benefits and risks provides for a weighted scoring system. The difference has been determined in accordance with the conclusion that potential benefits associated with advanced engineering projects typically outweigh any risk involved. In an alternative embodiment, a non-weighted scoring system may be used, wherein the potential benefits and risks are assigned equal maximum sub-scores.

Having assigned the maximum sub-scores, a range of impact factors are defined 206 of FIG. 3. In the embodiment illustrated, the range of impact factors includes 1-3. It should be appreciated that in an alternative embodiment, the range of impact factors may include any ascending or descending range of numbers. It should further be appreciated that the impact factors apply to the potential benefits and risks on an inverse relationship. For example, an impact factor of “3” assigned to a potential benefit indicates that a successful project will provide great benefits to the Organization, while an impact factor of “1” assigned to a potential benefit indicates that a successful project will have low benefits to the Organization. Alternatively, an impact factor of “3” assigned to a potential risk indicates that there is a low risk in pursuing the Proposed Project, while an impact factor of “1” assigned to a potential risk indicates that there is a high risk in pursuing the Proposed Project. Thus, a higher impact factor always indicates a positive aspect to the Proposed Project.

Having identified the range of impact factors, weight factors are derived at step 208 of FIG. 3. The weight factors are derived by dividing the maximum sub-scores by the maximum impact factor. Thus, FIGS. 7A-7D present a weight factor of 100 for each of the potential benefits and a weight factor of 66.6 for each of the risks. Next, specific impact factors for each potential benefit and risk are assigned.

First, an impact factor is assigned to the Strategic Advantage potential benefit at step 210 of FIG. 3. In assigning the Strategic Advantage impact factor, the Organization's competitors are considered, particularly, the types of products and services, as well as the quantity of those products and services provided by the competitors. If the competitors are not providing products and/or services similar to those that the Organization aims to achieve from a Proposed Project, the Organization may gain a clear Strategic Advantage by introducing that product or service to the market. Furthermore, if information gathered can establish that a competitor is conducting a project similar to a Proposed Project, the Organization may be able to determine the status of that project and attempt to beat the competitor's product to market, which would also provide a Strategic Advantage.

Next, an impact factor is assigned to the Market Advantage potential benefit at step 212 of FIG. 3. In assigning the Market Advantage impact factor, the Organization's competitors are again considered, particularly, the types of products and services, as well as the quality and quantity of those products and services provided by the competitors. If the Organization's competitors are not providing products and/or services similar to those the Organization aims to achieve from a Proposed Project, the Organization may gain a Market Advantage by introducing that product or service to the customers. Furthermore, if the competitors do provide a similar product, but the Organization feels it can provide a product of higher quality, the same market advantage may be achieved.

Next, an impact factor is assigned to the Technical Risk and Cost Risk potential risks at steps 214 and 216 of FIG. 3. The customer requirements provided in FIG. 4 and the gap graph in FIG. 6 are all considered in determining impact factors for the potential risks.

FIG. 6, as stated above, provides an objective comparison of the amount of work required to successfully complete each of the Proposed Projects. It is important to note, however, that each project must be considered separately before being compared. For example, FIG. 6 illustrates that the Organization must complete 50% of the parameters defined in Proposed Project D to successfully complete Project D. FIG. 6 also illustrates that the Organization must complete 20% of the parameters defined in Proposed Project A to successfully complete Project A. Therefore, at first glance, it seems as though Project A requires less work than Proposed Project D to complete. This may not be necessarily true. It could be that Proposed Project D involves less complex technology and/or a smaller number of total parameters than Proposed Project A, which would tend to reduce the work required to complete Project D. Nevertheless, the bar graph of FIG. 6 provides some insight into the technical risks involved. It helps quantify the number of remaining technical hurdles for each Proposed Project, relative to the project as a whole.

Furthermore, FIG. 4 can also provide insight into the risks associated with each Proposed Project. FIG. 4 illustrates what results are required by what customers, and the urgency of those results. Therefore, FIG. 4 enables one to address what Proposed Projects are high priority and for what customers. For example, C1 urgently demands results from Project A, but it may also be known that C1 will only provide moderate revenue to the Organization for those results Additionally, C2 foresees that it will require results from Project C within 2-3 years. It may also be known that, if provided, C2 could utilize those results immediately, although they are not required. Furthermore, it could be that C2 will provide great amounts of revenue to the Organization for those results today. Thus, the Organization may choose to pursue Project C rather than Project A because it is less of a financial risk.

With reference back to FIGS. 7A-7D, it is illustrated that Project A has been assigned a Strategic Advantage impact factor of “3,” a Market Advantage impact factor of “3,” a Technical Risk impact factor of “2,” and a Cost Risk impact factor of “1.” This indicates that the potential benefits of Project A are considered to be great, while the potential risks of Project A are considered to be moderate to high. Thus, by multiplying each weight factor by the respective impact factor, a sub-score is calculated for each potential benefit and risk at step 218 in FIG. 3. Next, the sub-scores are summed to calculate a project score at step 220. Summing the sub-scores provides that Project A has a score of 798. FIGS. 7B-7D illustrate similar scoring processes for projects B-D. Project B has a score of 600, Project C has a score of 932, and Project D has a score of 832. These scores were determined in the same manner as the score for Project A.

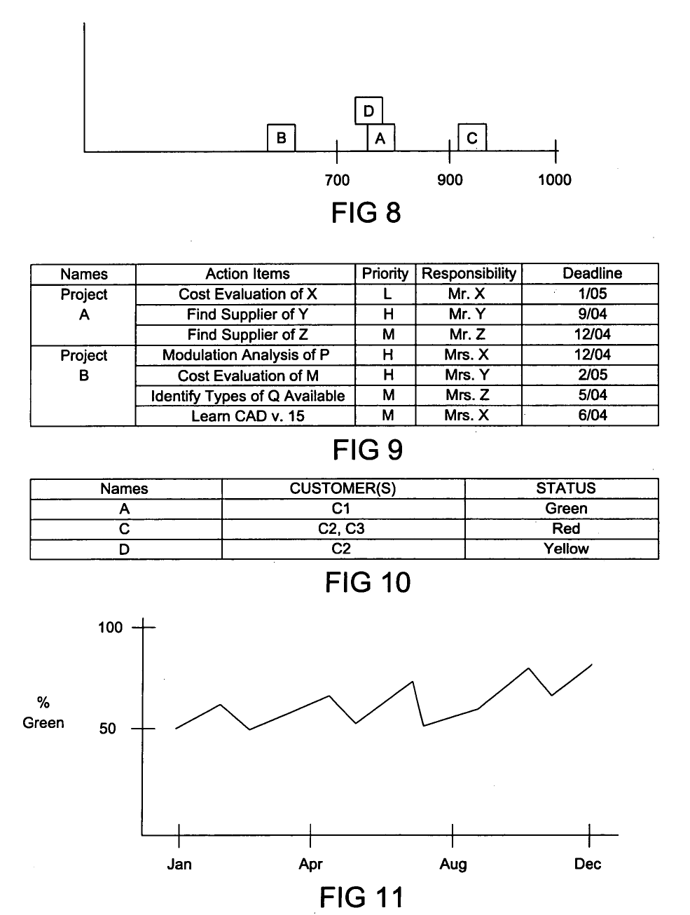

Referring back to the exemplary method of FIG. 2, the Proposed Projects are screened at step 126 after they have been scored. Prior to screening the projects, however, a low range of scores, a middle range of scores, and a high range of scores is delineated. Proposed Projects having a score within the low range of scores is considered to be of low importance, high risk, and/or low benefit. These Proposed Projects are eliminated from the advanced engineering program. Proposed Projects having a score within the middle range of scores are considered to be of high importance, high risk, and/or low benefit. Proposed Projects having a score within the high range of scores are considered to be of high importance, low risk, and high benefit. In an exemplary embodiment, the low range of scores contains scores 0-700; the middle range of scores contains scores 700-900; and the high range of scores contains scores 900-1000. FIG. 8 illustrates that Proposed Project B is within the low range of scores; Proposed Projects A and D are within the middle range of scores; and Proposed Project C is within the high range of scores. Therefore, Proposed Project B is eliminated from consideration and the screening phase ends at step 128 of FIG. 2. Next, Proposed Projects A, C, and D are activated at step 130. As previously discussed, activation of the Proposed Projects includes assigning project personnel, acquiring assets, setting goals, and distributing assignments.

With the selection phase and activation step completed, the tracking phase begins at step 132 of FIG. 2. First, a Master Project List is created 134 including all of the Active Projects. FIG. 9 depicts an exemplary Master Project List, wherein each Proposed Project is presented in a table that also includes categories common to all of the Active Projects. The categories include Action Items, Priority, Responsibility, and Deadline. The Action Items include a brief description of a technical task that needs to be completed for each Active Project. A priority is assigned to each action item. In the embodiment illustrated, the priorities include a low priority identified by an “L,” a moderate priority identified by an “M,” and a high priority identified by an “H.” These priorities are assigned by the project manager and/or the project personnel and inserted in the Priority column. The Responsibility column identifies the specific individual or individuals responsible for conducting the tasks necessary to complete the respective action item. The Deadline column identifies the date by which each respective task should be completed. This Master Project List provides a single glance into the work that remains for each Active Project, who is responsible for completing that work, and the deadline by which that work should be completed. In an exemplary embodiment, the Master Project List is stored on a computer-implemented system, thereby enabling all project personnel to access it. FIG. 13 depicts an exemplary computer implemented system 300. The system 300 includes a central computer center 302 and a plurality of terminals 304. The central computer center 302 is in data communication with the plurality of terminals 304 and includes an electronic storage device 306 and a processor 308. The storage device 306 is adapted to store information related to the projects. The processor 308 is adapted to process information received from the plurality of terminals 304. In an exemplary embodiment, the plurality of terminals 304 include personal computers.

In addition to maintaining a Master Project List, additional tools are implemented to track the status of each of the Active Projects. FIG. 10 depicts a status-tracking table, wherein it is identified at step 136 of FIG. 2 whether each Active Project is proceeding on time. The status-tracking table includes a list of the Active Projects, the customer or customers requiring results from the Active Projects, and the status of each Active Project. In the embodiment illustrated, a Green status represents that the project is running on time; a Yellow status indicates that the project is delayed, but no major problems exist; and a Red status indicates that the project is delayed and that at least one major problem exists. For each Active Project identified as Yellow or Red, a cause analysis is conducted 138. This analysis can include conducting a meeting of the project personnel to identify the cause or causes for the delay and/or major problem. Causes for a delay may include lack of resources, failure to receive input data from customers, or failure to obtain assets. It is envisioned that once the causes and problems have been identified, a supplemental action item list is compiled to define the tasks required to overcome the cause and/or problems. This supplemental action item list should be scheduled to be completed in the shortest timeframe possible.

In an exemplary embodiment, the status-tracking table illustrated in FIG. 10 is created on a periodic basis, such as monthly, bi-monthly, bi-annually, or annually. After a number of iterations of the status-tracking table have been completed, an overview of the advanced engineering program over time can be assessed. FIG. 11 depicts this assessment by presenting a plot of the percentage of projects proceeding on time at a plurality of points in time. For example, FIG. 11 illustrates that approximately 50% of the Active Projects were proceeding on time in the month of January. In addition to tracking the time status of each Active Project, costs are also tracked at step 140 of FIG. 2.

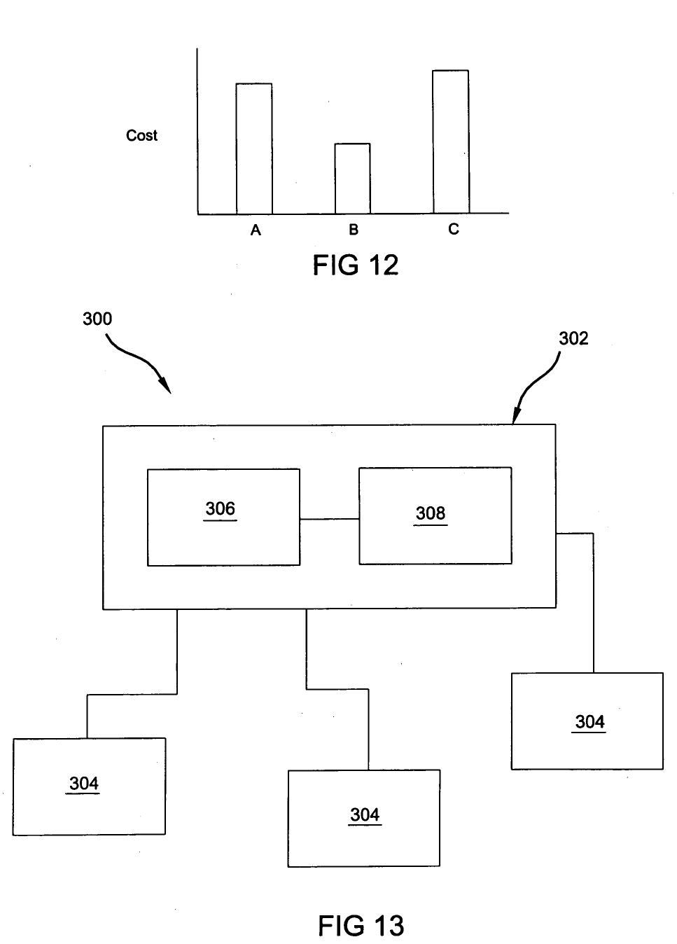

FIG. 12 illustrates a bar graph presenting how much money has been spent on each of the Active Projects. This provides a general cost comparison between the Active Projects. Furthermore, the total cost of each project may be summed to determine the total cost of the Organization's advanced engineering program. It should be appreciated that this cost-tracking tool may also be repeated on a periodic basis. Furthermore, the changes in the cost for each Active Project may be plotted against time, thereby illustrating an increase or decrease in spending. Completion of the status and cost-tracking analyses ends the tracking phase, as represented by reference numeral 142 in FIG. 2. At some point subsequent to the tracking phase ending, at least one Active Project is completed 144. Next, closing information is compiled 146.

The closing information is preferably compiled onto a computer-implemented system similar to that described above with reference to FIG. 13. The computer-implemented system 300 is helpful in gathering the closing information from a variety of sources. In the case of a project resulting in a new product, the closing information includes a storybook identifying the setbacks and hurdles of the project, product performance figures, product durability figures, a feasibility analysis for the manufacturing and marketing of the product, a cost estimate for the manufacturing of the product, and the actual product. In the case of a project resulting in a service, the closing information compiled on the computer-implemented system includes a storybook of the project detailing its setbacks and hurdles, a report detailing the capabilities of the services, and a cost estimate for rendering such services. It should be appreciated that while certain information has been listed herein as being compiled for the customer, alternative or supplemental information is intended to be within the scope of the present invention. Finally, after the information is compiled onto the computer-implemented system 300, the closing information is delivered to the customer at step 148.

The description of the invention is merely exemplary in nature and, thus, variations that do not depart from the gist of the invention are intended to be within the scope of the invention. Such variations are not to be regarded as a departure from the spirit and scope of the invention.

1. A method of managing advanced engineering activities, comprising:
collecting customer requirements from a plurality of customers;
proposing a plurality of projects tailored to satisfy the customer requirements;
comparing internal capabilities with the customer requirements for each proposed project;
defining a gap for each proposed project as a difference between the customer requirements and the internal capabilities; and
scoring each proposed project to determine which proposed projects to activate.

2. The method of claim 1 wherein the customer requirements include an identification of how urgently each customer requires a result from each of the proposed projects and a plurality of parameters specifying the result required from each proposed project.

3. The method of claim 1 wherein scoring each proposed project includes:
quantifying a benefit;
quantifying a risk; and
summing the risk and benefit to derive a score.

4. The method of claim 3 wherein quantifying a benefit includes:
defining a potential benefit common to all proposed projects; and
assigning benefit points to the potential benefit for each proposed project, the benefit points being selected from a range of points, wherein higher points correlate to a greater benefit.

5. The method of claim 3 wherein quantifying a risk includes:
defining a potential risk common to all proposed projects; and
assigning risk points to the potential risk for each proposed project, the risk points being selected from a range of points, wherein higher points correlate to a lower risk.

6. The method of claim 1 further comprising selecting the proposed projects having scores above a predetermined minimum value.

7. The method of claim 6 further comprising activating the selected projects.

8. The method of claim 7 further comprising compiling a list of the activated projects.

9. The method of claim 8 further comprising:
completing one or more of the activated projects to provide a result therefrom;
compiling closing information describing the completed projects and the result; and
delivering the closing information and the results to at least one customer.

10. The method of claim 9 further comprising storing the list and closing information on a computer-implemented system.

11. The method of claim 8 wherein the list includes at least one of priority information, technical information, responsibility assignments, timeline estimations, and cost estimates for each activated project.

12. The method of claim 9 wherein the result is at least one of a product and a service.

13. The method of claim 1 further comprising determining a percentage of activated projects that are proceeding on time.

14. The method of claim 1 further comprising monitoring costs associated with each of the activated projects.

15. The method of claim 14 wherein the costs include at least one of labor costs, material costs, and facility costs.

16. A method of managing advanced engineering activities, comprising:
collecting customer requirements from a plurality of customers;
proposing a plurality of projects tailored to satisfy the customer requirements;
collecting internal capabilities for each of the proposed projects;
quantifying a benefit for each proposed project, each benefit being derived from a consideration of at least one of the customer requirements and the internal capabilities;
quantifying a risk for each proposed project, each risk being derived from a consideration of at least one of the customer requirements and the internal capabilities;
determining a score for each proposed project as a function of the benefit and risk associated therewith; and
activating proposed projects having a score above a predetermined minimum.

17. The method of claim 16 wherein the customer requirements include an identification of how urgent each customer requires a result from each of the proposed projects and a plurality of parameters specifying the results required.

18. The method of claim 16 wherein quantifying a benefit for each proposed project includes:
defining a potential benefit common to all proposed projects; and
assigning benefit points to the potential benefit for each proposed project, the benefit points being selected from a range of points, wherein higher points correlate to a greater benefit.

19. The method of claim 16 wherein quantifying a risk includes:
defining a potential risk common to all proposed projects; and
assigning risk points to the potential risk for each proposed project, the risk points being selected from a range of points, wherein higher points correlate to a lower risk.

20. The method of claim 16 further comprising compiling a list of the activated projects.

21. The method of claim 20 further comprising:
completing one or more of the activated projects to provide a result;
compiling closing information for each completed project describing the project and the respective result; and
delivering the closing information and the result to a customer.

22. The method of claim 21 further comprising storing the list and the closing information on a computer-implemented system.

23. The method of claim 22 wherein the list includes at least one of priority information, technical information, responsibility assignments, timeline estimations, and cost estimates for each proposed project.

24. The method of claim 16 further comprising determining a percentage of activated projects that are proceeding on time.

25. The method of claim 16 further comprising monitoring costs associated with each of the activated projects.

26. The method of claim 25 wherein the costs include at least one of labor costs, material costs, and facility costs.

27. A method of managing advanced engineering activities within an organization, said method comprising:
collecting customer requirements from a plurality of customers;
activating a plurality of projects tailored to satisfy the customer requirements;
completing at least one of the activated projects to provide a result meeting at least a portion of the customer requirements;
compiling closing information describing the completed projects and their respective results, wherein the compiling occurs on a computer-implemented system; and
delivering the closing information and the result to at least one customer.

28. The method of claim 27 wherein the customer requirements include an identification of how urgent each customer requires the result and a plurality of parameters specifying the required result.

29. The method of claim 27 wherein activating a plurality of projects includes compiling a list of the projects.

30. The method of claim 29 wherein the list includes at least one of priority information, technical information, responsibility assignments, timeline estimations, and cost estimates for each project.

31. The method of claim 27 wherein the results include at least one of a product and a service.

32. The method of claim 27 further comprising comparing internal capabilities with the customer requirements to define a gap for each of the projects prior to activating a plurality of projects.

33. The method of claim 32 further comprising scoring each project prior to activating a plurality of projects, including:
quantifying a benefit;
quantifying a risk; and
summing the risk and the benefit to derive a score.

34. The method of claim 33 wherein quantifying a benefit includes:
defining a potential benefit common to all projects; and
assigning benefit points to the potential benefit for each project, the benefit points being selected from a range of points, wherein higher points correlate to a greater benefit.

35. The method of claim 34 wherein quantifying a risk includes:
defining a potential risk common to all projects; and
assigning f risk points to the potential risk for each project, the risk points being selected from a range of points, wherein higher points correlate to a lower risk.

36. The method of claim 33 further comprising selecting projects having a score above a predetermined minimum to be activated.

37. The method of claim 36 wherein activating a plurality of projects includes activating only the selected projects.
